(19) United States
(12) Patent Application Publication
(10) Pub. No.: US 2001/0050203 A1
(43) Pub. Date: Dec. 13, 2001

(54) Dynamic damper

(75) Inventor: Naohito Kuwayama, Nagoya-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOKAI RUBBER INDUSTRIES, LTD., Komaki-shi Aichi (JP)

(21) Appl. No.: 09/767,889

(22) Filed: Jan. 24, 2001

(30) Foreign Application Priority Data
Jun. 9, 2000 (JP) 2000/173034

(51) Int. Cl. F16F 7/10

(52) U.S. Cl. 188/379

(57) ABSTRACT

A dynamic damper is provided comprising a tubular mass member 11, a pair of elastic joining regions 13 of a tubular shape having an inner diameter smaller than that of the mass member 11, arranged coaxially, and spaced by a specific distance outwardly from the axial ends of the mass member 11, and a pair of elastic arm regions 14 shape of a tubular, each arm region arranged to join throughout the circumference between one axial end of the mass member and one of the paired joining regions 13. A boundary 15 of the inner surface between the elastic joining region and the elastic arm region 14 is located on the outside of the axial ends of the mass member 11. The elastic arm region 14 is sloped and arranged in a funnel-like shape which becomes wider from the boundary 15 towards the axial ends of the mass member 11. The boundary 15 is shaped to an edge of which the curvature radius is not larger than 1 mm. The inner surface of the elastic arm region 14 forms an arcuate recess 14a thereof curved outwardly about the axis.

### BACKGROUND OF THE INVENTION

The present invention relates to a dynamic damper securely fitted onto a rotary shaft, such as the drive shaft of a vehicle, for damping vibrations generated on the rotary shaft.

In general, such a dynamic damper comprises, as shown in FIG. 6, a tubular mass member 1, a pair of elastic joining regions 2 of a tubular rubber material having an inner diameter smaller than that of the mass member 1 and arranged coaxially as spaced by a given distance outwardly from the axial ends of the mass member 1, and a pair of elastic arm regions 3 of a rubber material, each elastic arm region arranged to a tubular form to join throughout the circumference between the axial end of the mass member 1 and the paired elastic joining regions 2, and provided with a boundary 4 between its inner surface and the inner surface of the paired elastic joining region 2 situated on the outside of the axial end of the mass member 1, the elastic arm region 3 sloped and arranged in a funnel-like shape made gradually wider from the boundary 4 towards the axial ends of the mass member 1. The dynamic damper is fitted onto by pressing and secured at its two joining regions 2 with the drive shaft (not shown). For ease of the production and the fitting onto the driver shaft, the dynamic damper has each boundary 4 between the inner surface of the joining region 2 and the inner surface of the arm region 3 rounded by 2R (curvature radius of 2 mm)or more.

As its boundary 4 of the inner surface between the joining region 2 and the arm region 3 is rounded by 2R or more, the conventional dynamic damper fitted on the drive shaft by pressing may hardly be uniform due to variations in pressing force in the contact area of its boundary 4 and the drive shaft hence causing its arm region 3 to be relatively varied in the length. This results in the increase of a change in the resonance frequency of the dynamic damper, hence lowering the effect of damping the vibrations.

In particular, when the drive shaft is slightly altered in the diameter, the change in the contact area or namely the resonance frequency will be emphasized. Accordingly, it is mandatory to prepare various types of the dynamic damper corresponding to different types of the drive shaft which are slightly varied in diameters. This will significantly be disadvantageous in the manufacturing process and the inventory management of the dynamic dampers.

### SUMMARY OF THE INVENTION

The present invention has been developed for eliminating the above disadvantage and its object is to provide a dynamic damper which can minimize changes in the resonance frequency when mounted to a rotary shaft of a slightly different outer diameter and even when develops uneven pressure during the fitting process.

For achievement of the above object, a dynamic damper according to the present invention comprises: a tubular mass member; a pair of elastic joining regions of rubber material and a tubular shape having an inner diameter smaller than that of the mass member, arranged coaxially, and spaced by a specific distance outwardly from the axial ends of the mass member; and a pair of elastic arm regions of a tubular rubber material, each arm region arranged to join throughout the circumference between one axial end of the mass member and one of the paired joining regions, its boundary of the inner surface with the inner surface of the joining regions located on the outside of the axial end of the mass member, its shape sloped and arranged in a funnel-like shape which becomes wider from the boundary towards the axial end of the mass member, so that the dynamic damper can be fitted onto and secured at its elastic joining regions with a rotary shaft, wherein the boundary is shaped to an edge of which the curvature radius is not larger than 1 mm. The curvature radius of the boundary is preferably not larger than 1 mm and more preferably not larger than 0.5 mm.

When the dynamic damper is fitted onto the drive shaft by pressing, its boundary of the inner surface between the elastic joining region and the elastic arm region, which is edged at a curvature radius of not larger than 1 mm and thus sized precisely, can favorably make the contact area of the dynamic damper against the drive shaft not irregular but uniform in spite of variations in pressing force during the fitting process. As a result, the length of the elastic arm regions can rarely be varied. As the dynamic damper is highly steady in the resonance frequency, its vibration damping effect will be improved.

According to the present invention, the inner surface of the elastic arm region may form an arcuate recess thereof curved outwardly about the axis. Since the arcuate recess curved outwardly about the axis is provided in the inner surface of each elastic arm region, its curved shape makes the contact area of the dynamic damper against the drive shaft not irregular but more uniform when the dynamic damper is fitted by pressing onto the drive. Similarly, the contact area becomes less irregular when different types of the rotary shaft which are slightly different in the outer diameter are provided. This allows the single dynamic damper to be equally fitted onto a range of the drive shafts of which the outer diameter varies to some extents, hence contributing to significantly the reduction of the production cost and the inventory cost of the dynamic damper.

Alternatively, the boundary may be implemented by a vertical wall which extends radially between the inner surface of the elastic joining region and the inner surface of the elastic arm region. When the dynamic damper is fitted onto the drive shaft by pressing, its boundary of the inner surface between the elastic joining region and the elastic arm region can favorably make the contact area of the dynamic damper against the drive shaft not irregular but uniform in spite of variations in pressing force during the fitting process. Similarly, the contact area becomes less irregular when different types of the rotary shaft which are slightly different in the outer diameter are provided. This permits the single dynamic damper to be equally fitted onto a range of the drive shafts of which the outer diameter varies to some extents, hence contributing to significantly the reduction of the production cost and the inventory cost of the dynamic damper.

### BRIEF DESCRIPTION OF THE DRAWINGS

FIG. 1 is a cross sectional view along the axis of a dynamic damper showing one embodiment of the present invention;

FIG. 2 is a side view of the dynamic damper;

FIG. 3 is a cross sectional view along the axis of the dynamic damper fitted onto a drive shaft;

FIG. 4 is a cross sectional view along the axis of a dynamic damper showing another embodiment 1 of the present invention;

FIG. 5 is a cross sectional view along the axis of a dynamic damper showing another embodiment 2 of the present invention; and

FIG. 6 is a cross sectional view along the axis of a conventional dynamic damper.

### DETAILED DESCRIPTION OF THE PREFERRED EMBODIMENT

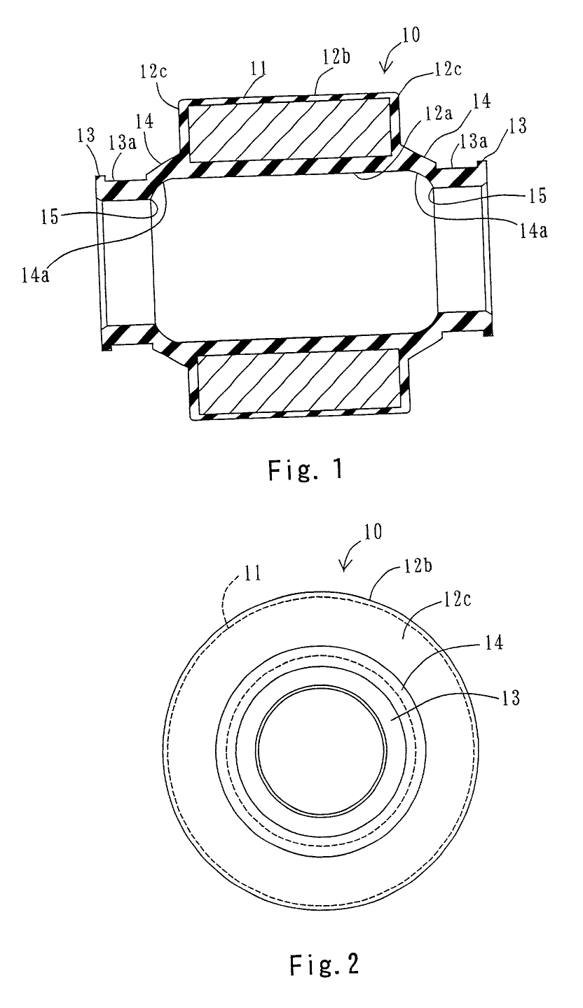

One preferred embodiment of the present invention will be described referring to the relevant drawings. FIGS. 1 and 2 are a cross sectional front view and a side view illustrating a dynamic damper of the embodiment mounted to the drive shaft of a vehicle. The dynamic damper 10 comprises a tubular mass member 11, a pair of elastic joining regions 13 made of a tubular rubber material arranged coaxially and spaced by a specific distance outwardly from the axial ends of the mass member 11 (referred to as joining regions hereinafter), and a pair of elastic arm regions 14 made of a tubular rubber material, each arm region arranged to join throughout the circumference between the axial end of the mass member 11 and the paired joining regions 13 (referred to as an arm region hereinafter).

The mass member 11 is covered at its inner surface with a thick rubber coating 12a and at its outer surface and its axial ends with thin rubber coatings 12b and 12c respectively. The inner diameter of the rubber coating 12a is a few millimeters greater than the outer diameter of the drive shafts. As the mass member 11 is entirely covered with the rubber coatings 12a, 12b, and 12c, it provides an anti-corrosion effect and can be coupled at both ends to the elastic arms 14 with stability. Alternatively, the mass member 11 may be covered with the rubber coatings not entirely but partially.

The joining regions 13 are slightly greater in the wall thickness than the rubber coating 12a and their inner diameter is substantially 1 mm smaller than the outer diameter of the drive shaft S. Each joining region 13 has a retaining groove 13a provided coaxially in the outer surface thereof for accepting an annular tightening member (not shown).

The arm region 14 of the tubular form is adapted to join throughout the circumference between one axial end of the joining region 13 and corresponding areas of the rubber coatings 12a and 12c of the mass member 11. In particular, a boundary 15 of the inner surface provided between the joining region 13 and the arm region 14 is located on the outside of the axial end of the mass member 11. The arm region 14 is sloped and arranged in a funnel-like shape which becomes wider from the pair of joining region 13 towards the axial end of the mass member 11. In addition, the inner surface of the arm region 14 forms an arcuate recess 14a thereof curved outwardly about the axis. Moreover, the boundary 15 between the arcuate recess 14a of the arm region 14 and the inner surface of the joining region 13 is shaped to an edge of which the curvature radius R1 is not larger than 1 mm. The rubber coatings 12a to 12c, the joining regions 13, and the arm regions 14 are integrally mold-formed by vulcanized rubber molding in a set of molds where the mass member 11 is placed, hence forming the dynamic damper 10.

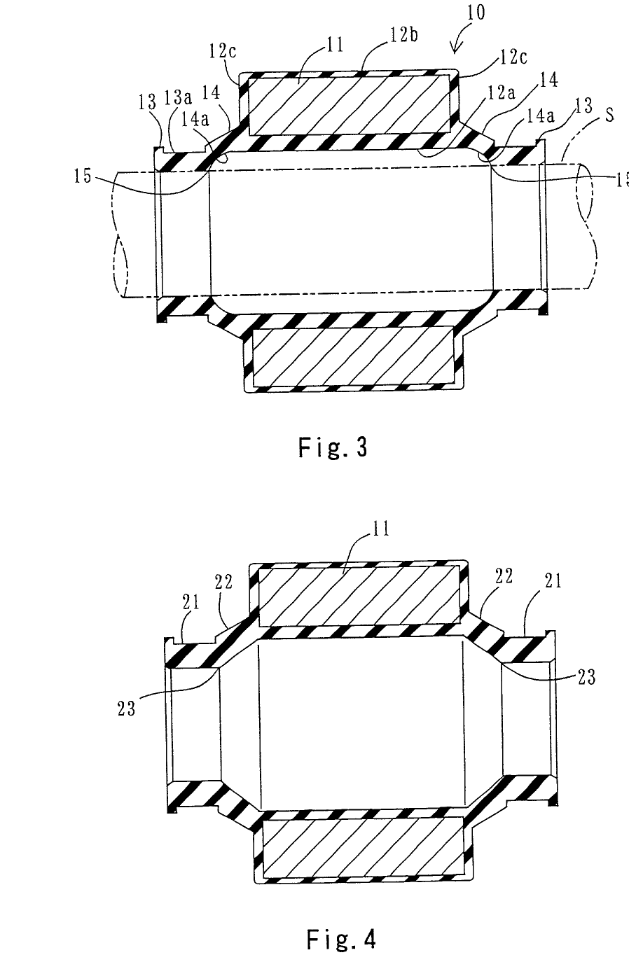

The dynamic damper 10 is then fitted by pressing with the use of a hand or a tooling onto the drive shaft S of a vehicle on which a press fitting lubricant is applied as shown in FIG. 3 and secured to its joining regions 13. The dynamic damper 10 allows the mass member 11 to develop a resonance effect by its vibration and thus promote shear deformation of the arm regions 14 for absorbing and damping the undesired vibrations generated by bending and twisting actions of the drive shaft S which spins rapidly.

Meanwhile, when the dynamic damper 10 is fitted onto the drive shaft S by pressing, its boundary 15 of the inner surface between the joining region 13 and the arm region 14, which is edged at a curvature radius of not larger than 1 mm and thus sized precisely, can favorably offset with its elasticity any uneven pressure urged during the fitting process and make the contact area of the dynamic damper 10 against the drive shaft S caused by enlarging the diameter of the boundary 15 not irregular but uniform. As a result, the length of the arm regions 14 can be maintained consistent. As the dynamic damper 10 is highly steady in the resonance frequency, its vibration damping effect will be improved.

Also, as the arcuate recess 14a curved outwardly about the axis is provided in the inner surface of each the arm region 14, its dimensional flexibility makes the contact area of the dynamic damper 10 against the drive shaft S not irregular but more uniform when the dynamic damper 10 is fitted onto the drive shaft S particularly regardless of a variation of the outer diameter of the drive shaft S. This allows the single dynamic damper 10 to be equally fitted onto a range of the drive shaft S of which the outer diameter varies two to three millimeters, hence contributing to significantly the reduction of the production cost and the inventory cost of the dynamic damper 10.

Another embodiments of the dynamic damper of the present invention will now be described.

Referring to FIG. 4, another embodiment 1 is arranged in which the inner surface of each arm region 22 which has a funnel-like shape becoming wider from a joining region 21 towards the axial end of the mass member 11 is not curved outwardly but made flat forming a simple cone-like shape while a boundary 23 of the inner surface between the joining region 21 and the arm region 22 is shaped to an edge of which the curvature radius R1 is not larger than 1 mm similar to that of the previous embodiment. In another embodiment 1, the contact area against the drive shaft S caused by enlarging the diameter of the boundary 23 can be made not irregular but uniform regardless of uneven pressure urged by the fitting process. Accordingly, the length of the arm regions 22 can be maintained consistent. As the dynamic damper of this embodiment is highly steady in the resonance frequency, its vibration damping effect will be improved.

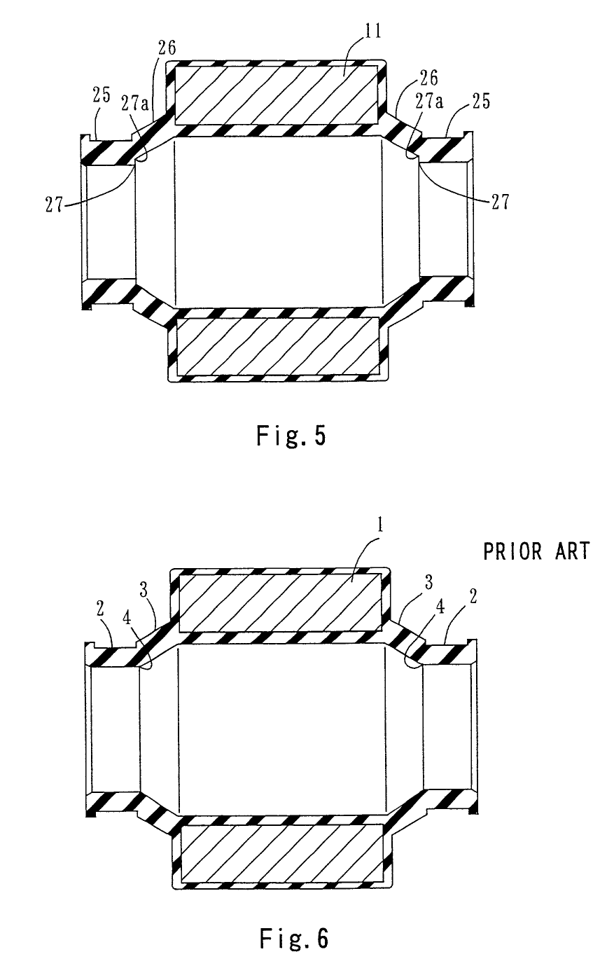

As shown in FIG. 5, another embodiment 2 is arranged in which a boundary 27 of the inner surface between each joining region 25 and each arm region 26 is shaped of a vertical wall 27a which throughout the circumstance extends radially and outwardly from the inner end of the joining region 25 to the outer end connected to the inner surface of the arm region 26. The arm region 26 is arranged of the inner surface which has a funnel-like shape which becomes wider from the joining region 25 towards the ends of the mass member 11 and is not curved but made flat forming a simple cone-like shape.

In another embodiment 2 having the above arrangement, the contact area against the drive shaft S caused by enlarging the diameter of the boundary 27 can be made not irregular but uniform regardless of variation in pressing force in the fitting process. Accordingly, the length of the arm regions 26 can be maintained consistent. As the dynamic damper of this embodiment is highly steady in the resonance frequency, its vibration damping effect will be improved. Also, this arrangement makes the contact area against the drive shaft S not irregular but more uniform regardless of a variation of the outer diameter of the drive shaft S. This allows the single dynamic damper 10 to be equally fitted onto a range of the drive shaft S of which the outer diameter varies to some extents, hence contributing to significantly the reduction of the production cost and the inventory cost of the dynamic damper 10. The inner surface of the arm region 26 of another embodiment 2 may be curved concavely and outwardly as described above.

While the dynamic damper of the embodiment is mounted to the drive shaft of a vehicle for damping the vibrations, it may be applied with equal success to any other like application. The elastic material in the embodiment is not limited to rubber but may be selected from appropriate elastomers. It is understood that the dynamic damper described above is illustrative of the embodiment and various changes and modifications may be made without departing from the scope of the present invention.

What is claimed is:

1. A dynamic damper comprising:
a tubular mass member;
a pair of elastic joining regions of a tubular shape having an inner diameter smaller than that of said mass member, arranged coaxially, and spaced by a specific distance outwardly from the axial ends of said mass member; and
a pair of elastic arm regions of a tubular elastic body, each arm region arranged to join throughout the circumference between one axial end of said mass member and one of said paired elastic joining regions, its boundary of the inner surface with the inner surface of said pair of elastic joining regions located on the outside of the axial ends of said mass member, its shape sloped and arranged in a funnel-like shape which becomes wider from the boundary towards the axial ends of said mass member, so that the dynamic damper can be fitted onto the rotary shaft and secured at said elastic joining regions with the rotary shaft, wherein
the boundary is shaped to an edge of which the curvature radius is not larger than 1 mm.

2. A dynamic damper according to claim 1, wherein the inner surface of said elastic arm region forms an arcuate recess thereof curved outwardly about the axis.

3. A dynamic damper according to claim 1, wherein the boundary is implemented by a vertical wall which extends radially between the inner surface of said elastic joining region and the inner surface of said elastic arm region.
